(19) United States
(12) Patent Application Publication
(10) Pub. No.: US 2013/0342884 A1
(43) Pub. Date: Dec. 26, 2013

(54) Synthetic hologram reading device and method

(71) Applicant: Commissariat a I'energie atomique et aux energies alternatives, Paris (FR)

(72) Inventor: Christophe MARTINEZ, Grenoble (FR)

(21) Appl. No.: 13/921,725

(22) Filed: Jun. 19, 2013

(30) Foreign Application Priority Data
Jun. 20, 2012 (FR) 12/55779

(51) Int. Cl. G03H 1/26

(52) U.S. Cl. CPC G03H 1/26
USPC 359/9

(57) ABSTRACT

The present invention involves a device for reading the source image of a synthetic hologram constituting the Fourier transform of the source image formed on a support (40), comprising a lens (42) positioned for forming the Fourier transform of the hologram on an image detection system (44), the relative positions of said lens and of said support being selected so that a desired number of replicas of the image are displayed on a plane of the detection system, said device further comprising a processing system (48) capable of performing a combination of replicas of the image.

### CROSS-REFERENCE TO RELATED APPLICATIONS

The present application claims priority under 35 U.S.C. §119 of French Patent Provisional Application Serial Number 12/55,779, filed Jun. 20, 2012, the disclosures of which are incorporated by reference herein.

### BACKGROUND OF THE INVENTION

1. Field of the Invention

The present disclosure relates to a device and a method for reading a synthetic hologram and, more specifically, to a reading device compatible with holograms obtained from high-resolution source images.

2. Description of the Related Art

In many fields, especially in the luxury goods industry (for example, perfumery, jewelry, or leather goods), or in the field of drugs, fighting against the imitation of branded products is an everyday concern. Several methods and devices are currently used to attempt to guarantee the authenticity of branded products. Among such techniques, it has been provided to place, on the products to be identified, transparent chips having holograms formed thereon.

Such holograms are obtained from a visible image which is found on reading of the hologram. The presence of the hologram is difficult to detect with the naked eye, and its direct reading with no adapted reading device does not enable to identify the source image of the hologram.

Among different categories of holograms, computer-generated holograms (CGH) are particularly adapted to the forming of identification chips. Indeed, such holograms may be obtained by calculating the inverse Fourier transform of a source image, and by then etching the obtained result on a chip. These holograms are read by means of an easy-to-handle optical system, optically achieving the Fourier transform of the hologram. It is thus easy to obtain the source image of the hologram with an adapted reading device.

FIG. 1 illustrates a device for reading a synthetic hologram. In this drawing, the reading device is a reflection device. It should be noted that there exist similar reading devices operating in transmission mode (the useful light beam crosses the support having the hologram formed thereon).

A light source 10, for example, a laser, generates a light beam 12 which is shaped by an optical system 14. The optical system transforms beam 12 into a beam having a selected diameter, which is transmitted towards a support 16 having a hologram formed thereon.

A beam splitter cube 18 is placed between the output of optical system 14 and hologram 16. Splitter cube 18 recovers the beam reflected by the hologram and transmits it towards a lens 20 arranged so that the field in the image plane of lens 20 is the Fourier transform of the field at the level of hologram 16. In the example of FIG. 1, lens 20 performs the holographic reconstruction in the plane of an image detection system 22, for example, a camera.

FIG. 2 illustrates the result obtained by means of a reading device such as that in FIG. 1, hologram 18 being a detour-phase hologram.

To form such a hologram, it is started from a source image of the hologram having its inverse Fourier transform calculated. Such a calculation provides an amplitude image and a phase image of the hologram. Each pixel of the hologram is formed of an opening formed in an opaque layer which extends on a support. For each pixel of the hologram, the size of the opening corresponds to the amplitude, and the position of the opening corresponds to the phase.

Advantageously, detour-phase holograms are easy to form by means of current thin opaque layer etching techniques, especially used in microelectronics. Such holograms may be formed in a single photolithography step, which is a non-negligible advantage over other hologram definition techniques. Especially, such a technique is simpler than techniques using a blade having a thickness varying according to the phase of the pixels.

FIG. 2 shows an example of detour-phase hologram 18. As can be seen in this example, the hologram pixels are aligned along a first axis y. The phase coding of the pixels is performed along a second axis x. For practical implementation reasons, but also for a better rendering on reading, openings 24 formed in an opaque layer 26 have an ellipsoidal shape.

FIG. 2 also illustrates the result of a reading of hologram 18, for example formed by means of the device of FIG. 1.

In reading plane 28, the incident signal is mainly in the zero order, referred to as 30, which generates an intense focusing spot at the center of the reading field. Another portion of the signal appears in diffraction orders 32 and 34 perpendicular to the shifting direction of the openings (in direction y). Such orders generate secondary focusing spots separated from the center of the field by a distance equal to Lf/L, L being the wavelength of the light beam illuminating the hologram, f being the focal distance of the lens, and L being the pitch of the hologram.

Two diffraction orders 36 (reconstructed image 39) and 38 of the hologram can be found on either side of the zero diffraction order, along axis x along which openings 24 are shifted. The two orders being conjugated, the two image distributions are symmetrical with respect to the center of the field. Each distribution is apodized (attenuated at the periphery) by a function in relation with the shape of the openings.

As the distance from the main order (order 0) increases, the signal is progressively attenuated.

A conventional reading of the hologram comprises selecting a portion of the image obtained in the reading plane, for example, by placing an image detection device at the level of reconstructed image 39 (diffraction order 38). However, most of the beam energy can be found in order zero where there is no holographic reconstruction effect. The rest of the signal is distributed in the other diffraction orders, which limits the image resolution in the different orders.

Thus, the resolution of the source image of the hologram cannot be strongly increased with a simple reading, especially when complex information such as a data matrix (Datamatrix or 2D bar code) is desired to be obtained. Indeed, to digitally detect a data matrix, it is necessary for the reconstructed image to have a sufficient quality to operate a decoding algorithm. Such an algorithm is based on concepts of redundancy and information overlapping enabling to manage possible disturbances on the detected image of the data matrix (damaged area, loss of contrast or of clearness, detection noise). Such an algorithm cannot be efficient if the data matrix is too disturbed.

There thus is a need for a reading device enabling to obtain an image of good quality.

### SUMMARY OF THE INVENTION

An object of an embodiment of the present invention is to provide a device and a method for reading a synthetic hologram providing a good-quality reading of the information contained in the hologram.

Another object of an embodiment of the present invention is to provide such a device which is compatible with shape detection algorithms.

Thus, an embodiment of the present invention provides a device for reading the source image of a synthetic hologram constituting the Fourier transform of the source image formed on a support, comprising a lens positioned for forming the Fourier transform of the hologram on an image detection system, the relative positions of said lens and of said support being selected so that a desired number of replicas of the image are displayed on a plane of the detection system, said device further comprising a processing system capable of performing a combination of replicas of the image.

According to an embodiment, the various components are sized to display in the plane of the detection system at least replicas of the orders −1,0 and 1,0.

According to an embodiment, the various components are sized to display in the plane of the detection system replicas of the orders −1,0 and 1,0 and replicas of the orders 1,1, −1,1, −1, −1 and 1, −1.

According to an embodiment, said combination is a calculation of the average of the different replicas.

According to an embodiment, the support is placed on the path of a beam originating from the light source before the lens, at a distance from the lens equal to its focal distance, the detection system being placed in the object focal plane of said lens, the lens having a focal distance f ranging between S/2 and SL/2G L and being preferably equal to SL/2G L, S being the width of the image detection system, L being the pitch of the hologram, G being the radius of the image field in number of holographic image widths, and L being the wavelength of the beam originating from the light source.

According to an embodiment, the support is placed on the path of a beam originating from the light source between the lens and the image detection system, the detection system being placed in the object focal plane of the lens, the distance d between said support and said detection system ranging between S/2 and SL/2G L and being preferably equal to SL/2G L, S being the width of the image detection system, L being the pitch of the hologram, G being the radius of the image field in number of holographic image widths, and L being the wavelength of the beam originating from the light source.

According to an embodiment, the optical function of the lens is contained in the hologram, the support being placed at a distance from the image detection system equal to the focal distance f of the lens, said focal distance ranging between S/2 and SL/2G L and being preferably equal to SL/2G L, S being the width of the image detection system, L being the pitch of the hologram, G being the radius of the detected image in number of holographic image widths, and L being the wavelength of the beam originating from the light source.

According to an embodiment, the diameter of the lens is at least equal to the width S of the image detection system.

According to an embodiment, a light source illuminating the hologram is selected to illuminate the entire surface of the hologram formed on the support.

According to an embodiment, the source image of the hologram is a data matrix.

According to an embodiment, a mask is provided at the center of the image detection system, to mask an order 0 image.

According to an embodiment, the mask has a diameter equal to Lf/4L, L being the wavelength of the beam originating from the light source, f being the focal distance of the lens, and L being the pitch of the hologram.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1, previously described, illustrates an example of a known device for reading a synthetic hologram;

FIG. 2 illustrates an example of result obtained by means of a reading device such as that in FIG. 1, on a detour-phase synthetic hologram;

FIG. 3 illustrates a result of the reading of a hologram originating from a source of data matrix type;

FIGS. 4, 5, and 6 illustrate rules of design of reading devices according to different embodiments; and

FIGS. 7A, 7B, 8A, and 8B illustrate a comparison of results of readings by means of a conventional reading device and by means of a reading device according to an embodiment.

For clarity, the same elements have been designated with the same reference numerals in the different drawings and, further, as usual in the representation of integrated circuits, the various drawings are not to scale. Thus although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

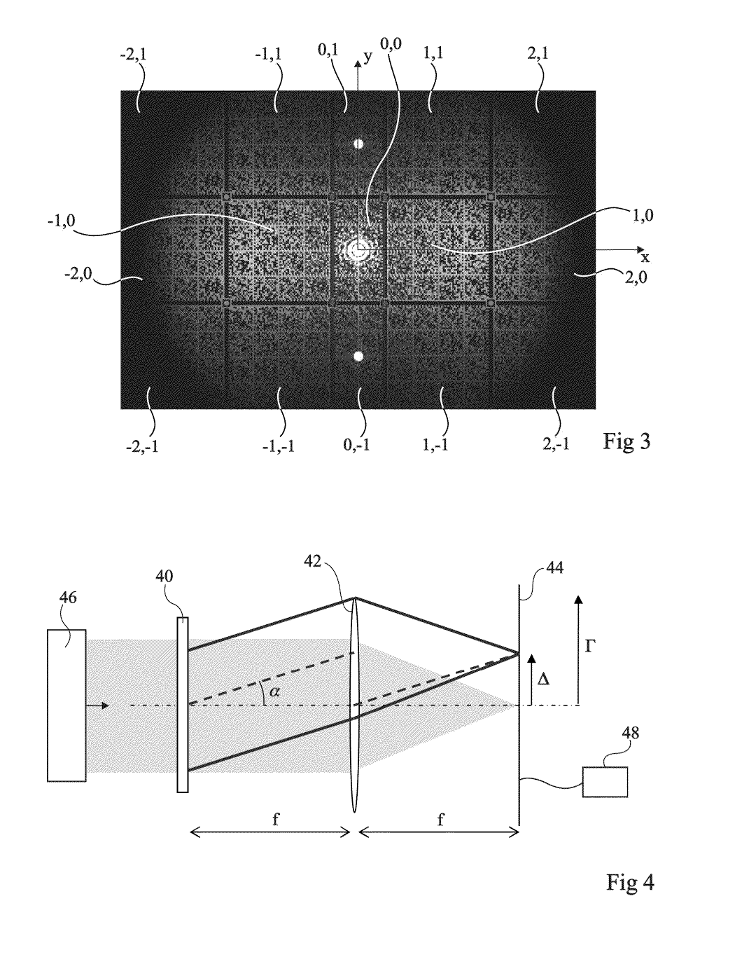

FIG. 3 illustrates the result of the reading of a synthetic hologram obtained from a source of data matrix type.

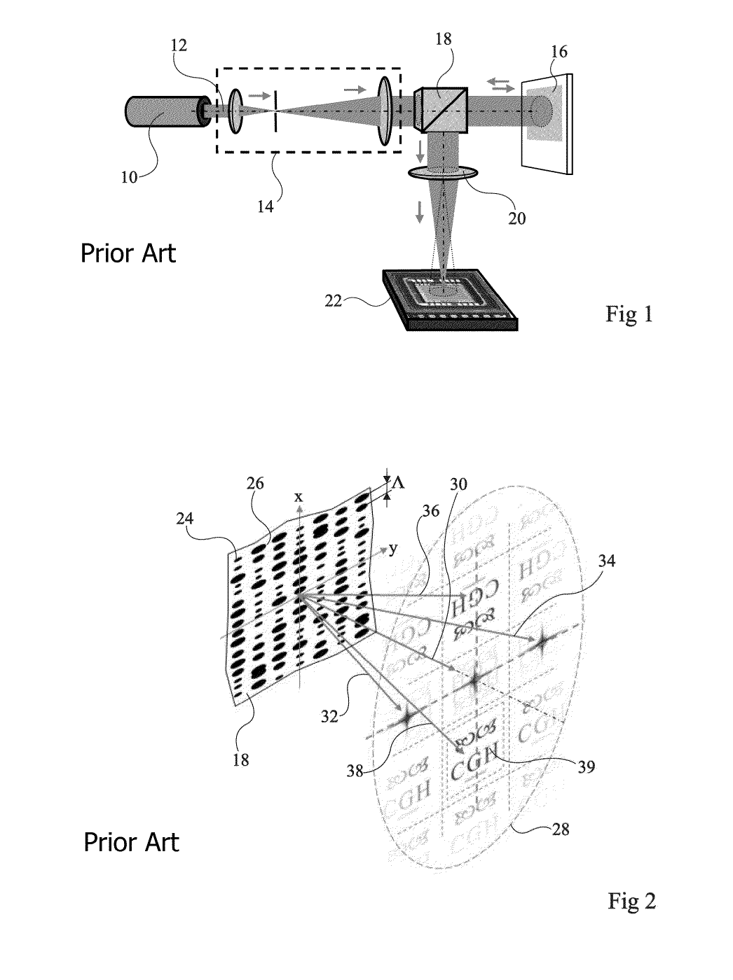

FIG. 3 shows, like FIG. 1, many replicas of the reconstituted source image. The center image (order 0,0) is not usable, as specified above, no more than the replicas (orders 0,1 and 0-1) disposed above and under the central order (00). However, the replicas of the other orders correspond to the source image of the hologram. The more brighting replicas correspond to the orders 1,0 and −1,0. Other replicas in the orders 1,1, −1,1, −1,−1 and 1,−1 are still relatively bright. The replicas of greater order are not very bright.

It will be noted that, in the embodiment of FIG. 3, to enhance the brightness of the replicas of the orders 1,0 and −1,0, the synthetic hologram has been modified so that the center of this replicas is closer from the center of the field situated at the order 0,0.

It is here provided, conversely to current devices for reading synthetic holograms which isolate one of the image replicas for the reading, usually the replica 1,0 or −1,0, to take advantage of the duplication of the source images of the hologram during the reading in the hologram reconstruction plane to improve the information decoding. Two replicas of the orders 1,0 and −1,0 or six replicas of the orders 1,0, −1,0 1,1, −1,1, −1,−1 and 1,−1 can be used, the latter replicas being fully or partially used.

To achieve this, the detection field is extended to collect several replicas of the source image, for example, of the data matrix. Each replicas containing the same information with different noise factors, the calculation of the average of the replicas enables to improve the detection of the coded data.

As can be seen in FIG. 3, the readability of the source image decreases as the distance from the light halo of order zero increases. This is especially due to the sizing of the lens in the reading system. Exemplary embodiments are disclosed below as regards reading devices having optimized dimensions to ensure the reading of a predetermined number of replicas, coupled to a data processing system detected by an image sensor, for example, a camera, enabling to provide an average over the different replicas of the image.

FIGS. 4, 5, and 6 illustrate rules of design of reading devices according to different embodiments.

After, the width of an image detection device where the acquisition of several replicas of the source image of the hologram during the reading is desired to be performed will be called S. Call L the hologram pitch, and L the wavelength of a beam originating from a light source for illuminating the reading device, for example a laser. Call Δ the holographic image width, that is, the size of a source image of the hologram obtained on the image detection device, and G the radius of the image field, in number of holographic image widths Δ, that is, a parameter characterizing the number of replicas of the image which are desired to be obtained on the image detection device.

In the case of FIG. 4, a reading device comprising a support 40 having a hologram formed thereon, a lens 42, and an image detection system 44 is provided. In this first case, the lens is placed between support 40 and image detection system 44. Support 40 is placed at a distance from the lens equal to focal distance f thereof, and image detection system 44 is placed at a distance from lens 42 equal to focal distance f thereof. A reading beam, originating from a light source 46, crosses the hologram before passing through lens 42 and being projected on detection system 44. A data processing system 48, schematically shown, is associated with detection system 44. In such a configuration, the positioning of the holographic reconstruction order at distance D from the optical axis, as well as the radius of image field G, has been shown.

In this case, the width of holographic image Δ is equal to Lf/L. To obtain an image field of desired radius G, in number of holographic image widths Δ, focal distance f of the lens should be selected to respect the following equation:

$$\frac{Σ}{2} \leq f \leq \frac{Σ . Λ}{2. Γ . λ}$$

It should be noted that the lower value of focal distance f is due to lens manufacturing limits, and to the fact that radius G is in practice at least equal to 2. Advantageously, focal distance f may be selected to be equal to the upper limit of the above range to optimize the extent of the desired holographic image distribution.

Further, and this, generally for the different cases of FIGS. 4 to 6, to enable to optimally reconstruct the image in the detector plane, the diameter of the lens will be at least equal to width S of the detection device.

It should further be noted that, rather than selecting a lens having a focal distance predetermined according to the above parameters, and especially according to the size of image detection system 44, it is possible to impose a focal distance of the lens and to obtain the minimum and maximum sizes of the detection system capable of reading the number of replicas of the desired image.

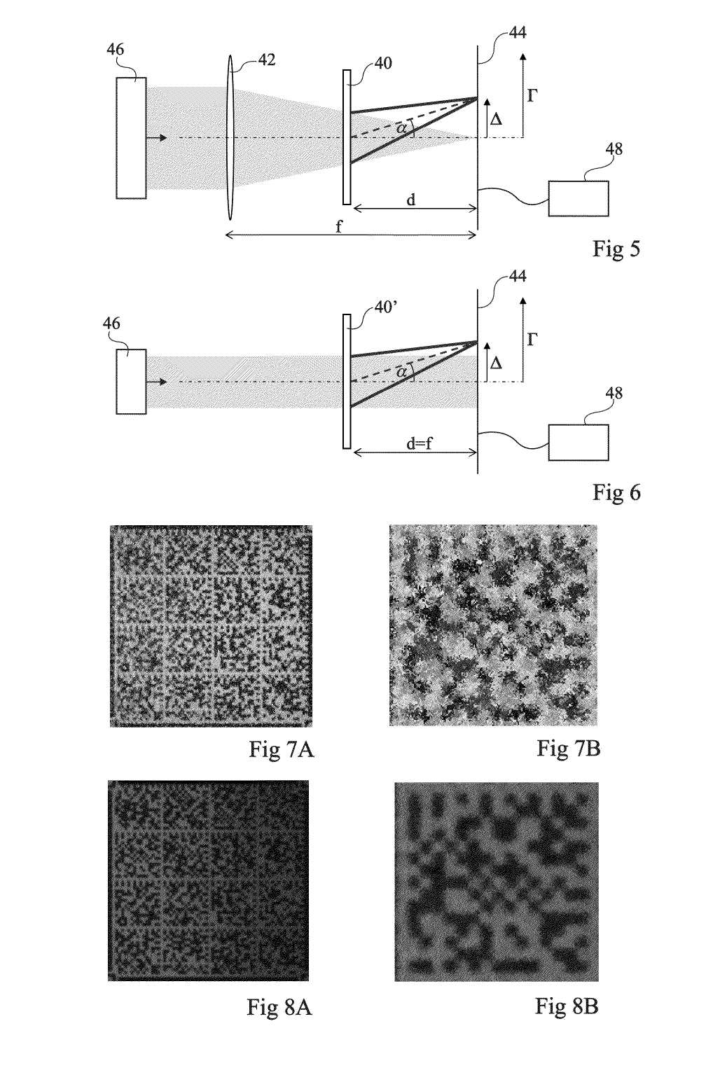

In the case of FIG. 5, a reading device comprising a support 40 of a hologram, a lens 42, and an image detection system 44 is provided. In this case, hologram 40 is placed between lens 42 and image detection system 44. lens 42 is placed at a distance from image detection system 44 equal to the focal distance thereof, and hologram 40 is placed with respect to image detection system 44 at a distance d.

A light source 46 illuminates the hologram formed on support 40, and a data processing system 48 is connected to image detection system 44. In such a configuration, the distance between holographic reconstruction order 1 and the optical axis of the device is no longer provided by the focal distance of the lens, but by distance d.

In this case, holographic image width Δ is equal to Ld/L. To obtain an image field of desired radius G, in number of holographic image widths Δ, distance d between the hologram and image detection system 44 should be selected to respect the following equation:

$$\frac{\sum }{2} \leq d \leq \frac{\sum \cdot Λ}{2 \cdot Γ \cdot λ}$$

Advantageously, distance d may be selected to be equal to the upper limit of the above range to optimize the extent of the desired holographic image distribution.

It should be noted that, rather than defining a reading device where distance d is set by the above parameters, and especially by the size of image detection system 44, it is possible to impose a distance d between support 40 and detection system 44 and to obtain the minimum size of the detection system capable of reading the desired number of replicas of the image.

In the case of FIG. 6, an alternative case where the lens is integrated to the phase function of the hologram to form a block 40′ is provided. In this case, block 40′ is placed at a distance from an image detection system 44 equal to focal distance f of the lens. A light source 46 illuminates support 40, and a data processing system 48 is connected to detection system 44.

In this case, the width of holographic image Δ is equal to Lf/L. To obtain an image field of desired radius G, in number of holographic image widths Δ, focal distance f of the lens should be selected to respect the following equation:

$$\frac{\sum }{2} \leq f \leq \frac{\sum \cdot Λ}{2 \cdot Γ \cdot λ}$$

Advantageously, focal distance f may be selected to be equal to the upper limit of the above range to optimize the extent of the desired holographic image distribution.

It should be noted that, in this last case, the reading light beam is not focused at the level of the surface of image detection system 44. The amplitude hologram introduces no phase function on the zero order, which implies for the introduced lens function to only be effective in the hologram diffraction orders.

As an example of digital application, it is possible to use a hologram having a pitch L=4 μm, and a light source having a wavelength L=650 nm, by selecting a parameter G=2. The used camera may comprise a sensor having a size equal to 8.6×6.9 mm2, width S being thus set to 8.6 mm. The above calculations provide a maximum focal length of 13.2 mm, a minimum focal length of 4.3 mm, with a lens diameter of at least 8.6 mm. One may thus select, for example, a lens catalogue reference having a focal distance of 12 mm and a 9-mm diameter. In this case, the radius of the image field becomes equal to 2.2 holographic images.

Advantageously, the use of a reading device parameterized according to one of the above solutions enables to have an image acquisition performed by image detection system 44 comprising a predetermined number of replicas of the source image of the hologram.

FIGS. 7A, 7B, 8A, and 8B illustrate a comparison of results of readings by means of a conventional reading device (FIGS. 7A and 7B) and by means of a reading device according to an embodiment (FIGS. 8A and 8B). More specifically, FIG. 7A illustrates the result of a direct reading of a single image of data matrix type in the reading plane, and FIG. 7B illustrates an enlargement of this reading. FIG. 8A illustrates the result of a reading of a source image of a hologram in the form of a data matrix in the reading plane by using the reading device of the invention, 12 replicas of the image being averaged in this case by processing system 48, and FIG. 8B is an enlargement of FIG. 8A.

As can be seen in these drawings, a simple reading of a single hologram source image appears to be of good quality at first sight. However, when the enlargement of FIG. 7B is considered, it can be seen that the details are little readable, which implies a resolution limit of the source image of the hologram and may pose data matrix decoding problems.

Conversely, the enlargement shown in FIG. 8B of the reading of FIG. 8A has a better reading resolution. One can thus, by adapting the reading device as mentioned hereabove, work with hologram source images of greater resolution, since the entire diffracted field is taken advantage of during the reading. The average achieved by processing system 48, for example a pixel-by-pixel average of the source image replicas, enables to decrease the influence of noise, but also ascertains that the energy diffracted by the structure is used with a better efficiency.

To make sure that the reading will occur properly, it should be noted that light source 46 will be selected to illuminate the maximum surface area of the hologram, possibly the entire hologram surface area.

Specific embodiments of the present invention have been described. Various alterations, modifications, and improvements will readily occur to those skilled in the art.

Especially, although the reading devices have been shown in FIGS. 4 to 6 as being transmission reading devices, the sizing rules provided herein easily adapt to reflection reading devices such as that in FIG. 1. For the case of FIG. 4, the lens is for example placed on the optical path between the beam splitter cube and the detection system and, for the case of FIG. 5, the lens is placed on the optical path, for example, before the beam splitter cube.

Further, it should be noted that the source image of the hologram may be provided with distinctive areas on its contour (alignment mark) to help detecting the images reconstructed by processing system 48.

Finally, to improve the reading, it may also be provided to modify image detection system 44 to define a blind area at the level of the central intensity peak. For example, this may be performed by pasting to the detection system a light trap pellet at the center of the detection system. The non-useful area at the center of the field covering approximately half the width of the base image, a blind area having a diameter equal to one quarter of this value, that is, equal to Lf/4L, may be selected.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A device for reading the source image of a synthetic hologram constituting the Fourier transform of the source image formed on a support, comprising a lens positioned for forming the Fourier transform of the hologram on an image detection system, the relative positions of said lens and of said support being selected so that a desired number of replicas of the image are displayed on a plane of the detection system, said device further comprising a processing system \capable of performing a combination of replicas of the image.

2. The device of claim 1, wherein the various components are sized to display in the plane of the detection system at least replicas of the orders −1,0 and 1,0.

3. The device of claim 1, wherein the various components are sized to display in the plane of the detection system replicas of the orders −1,0 and 1,0 and replicas of the orders 1,1, −1,1, −1,−1 and 1,−1.

4. The device of claim 1, wherein said combination is a calculation of the average of the different replicas.

5. The device of claim 1, wherein the support is placed on the path of a beam originating from the light source before the lens, at a distance from said lens equal to its focal distance, the detection system being placed in the object focal plane of said lens, the lens having a focal distance (f) ranging between S/2 and SL/2G L and being preferably equal to SL/2G L, S being the width of the image detection system, L being the pitch of the hologram, G being the radius of the image field in number of holographic image widths, and L being the wavelength of the beam originating from the light source.

6. The device of claim 1, wherein the support is placed on the path of a beam originating from the light source between the lens and the image detection system, the detection system being placed in the object focal plane of the lens, the distance (d) between said support and said detection system ranging between S/2 and SL/2G L and being preferably equal to SL/2G L, S being the width of the image detection system, L being the pitch of the hologram, G being the radius of the image field in number of holographic image widths, and L being the wavelength of the beam originating from the light source.

7. The device of claim 1, wherein the optical function of the lens is contained in the hologram, the support being placed at a distance from the image detection system equal to the focal distance (f) of the lens, said focal distance ranging between S/2 and SL/2G L and being preferably equal to SL/2G L, S being the width of the image detection system, L being the pitch of the hologram, G being the radius of the detected image in number of holographic image widths, and L being the wavelength of the beam originating from the light source.

8. The device of claim 1, wherein the diameter of the lens is at least equal to the width (S) of the image detection system.

9. The device of claim 1, wherein a light source illuminating the hologram is selected to illuminate the entire surface of the hologram formed on the support.

10. The device of claim 1, wherein the source image of the hologram is a data matrix.

11. The device of claim 1, wherein a mask is provided at the center of the image detection system, to mask an order 0 image.

12. The device of claim 11, wherein the mask has a diameter equal to Lf/4L, L being the wavelength of the beam originating from the light source, f being the focal distance of the lens, and L being the pitch of the hologram.
